(19) United States
(12) Patent Application Publication
(10) Pub. No.: US 2003/0079735 A1
(43) Pub. Date: May 1, 2003

(54) Baking oven construction

(76) Inventor: Robert S. Hines JR., Unicoi, TN (US)

Correspondence Address: Robert S. Hines, Jr., 150 Roller Lane, Unicoi, TN, 37692, US

(21) Appl. No.: 10/280,404

(22) Filed: Oct. 25, 2002

Related U.S. Application Data
(60) Provisional application No. 60/350,521, filed on Oct. 25, 2001.

(51) Int. Cl. A21B 1/08

(52) U.S. Cl. 126/20; 126/21 R; 126/273 R

(57) ABSTRACT

An oven construction wherein the oven wall forms an oven cavity containing in a lower portion thereof a HTA producing device, wherein a steam generator is provided in the cavity in physically isolated relationship to the device, wherein the steam generator contains a plurality of metal balls which act as a heat sink, and wherein a water reservoir is provided on the outside of the oven and is in water flow communication with the steam generator thru a water feed line.

This application claims priority under 35 U.S.C. 119(e)(1) based on Applicant's Provisional U.S. Patent Application Serial No. 60/350,521, filed Oct. 25, 2001 and titled “Baking Oven Steam Generator”.

### BACKGROUND OF THE INVENTION

1. Field

This invention concerns the modification of ovens, primarily of the rack type such as are used in homes, but also is useful in commercial size ovens, wherein the present modifications effect a unique hot air circulation pattern and, in a most preferred embodiment also features a conveniently located and easy to use unique steam generator. The present heated air circulation pattern dramatically improves the oven baking quality and efficiency and the generator provides limited bursts of steam to the oven in an improved manner to assist, e.g., in forming a thick, ruddy brown, crisp crust to bread particularly French bread being baked.

2. Prior Art

U.S. Pat. No. 5,680,810, the disclosure of which is hereby incorporated herein by reference in its entirety, discloses a radiant heat toaster oven provided with a steam generating system wherein a water filled tube is placed into contact with an electrical heating element whereby the water is brought to a boil and stem is allowed to escape thru vent holes in the tube.

### SUMMARY OF THE INVENTION

The present oven in one preferred embodiment comprises wall means forming a substantially closed cavity means having an upper portion and a lower portion, HTA (high temperature air) supply means mounted in said lower portion of said cavity means for generating a rising HTA flow within said cavity means, and air flow outlet means thru a lower section of said wall means, whereby said HTA from said supply means will rise into said upper portion of said cavity means and then as it becomes cooler will gravitate downwardly into said lower portion of said cavity means and exit thru said outlet means, whereby said HTA will be forced to travel a longer residence path within said cavity means and release a larger amount of heat energy into said cavity means prior to discharge of said HTA therefrom.

In another preferred embodiment a steam generator means is mounted in said cavity means and comprises water inlet means, heat sink means, steam outlet means, water reservoir means mounted on the exterior of said wall means on an upper portion thereof, and water feed line means passing thru said wall means and into said cavity means and having one end connected to said reservoir means and having its other end juxtaposed said inlet means, whereby a measured amount of water can be poured into said reservoir means and conducted thru said feed line means into said inlet means and into contact with said heat sink means to produce a desired amount of steam.

### BRIEF DESCRIPTION OF THE DRAWINGS

The present oven, in its preferred structural embodiments, is shown in FIGS. 1-13 wherein the scale and dimensions of the oven and steam generator components are shown for illustration of the invention only and are not intended to represent commercial ovens proportionately in size or configuration, wherein equivalent structure in the figures are numbered the same, and wherein;

FIG. 1 is a front view of an oven with portions of the oven front and door, and the steam generator broken away for clarity;

FIG. 2 is a side view taken along line 2-2 of FIG. 1 with portions broken away for clarity;

FIG. 3 is a cross sectional view taken along line 3-3 of FIG. 1;

FIG. 4 is a cross-sectional view as in FIG. 2 but showing a preferred positioning of the steam generator with respect to the oven heating element;

FIG. 5 is an isometric schematic of a portion of the oven interior showing preferred locations of the steam generator, water feed tube and water reservoir;

FIG. 6 is an isometric top view of a preferred steam generator tube;

FIG. 7 is a cross-sectional view taken along line 7-7 of FIG. 6 in the direction of the arrows;

FIG. 8 is an isometric view of an upright tube steam generator with portions broken away for clarity;

FIG. 9 is a front view of an oven with the front door and the front of the burner housing removed to show a preferred position for the steam generator of FIG. 8; .

FIG. 10 is a front view of an oven with the door removed to show how the steam generator feed tube is mounted to enter into the oven cavity;

FIG. 11 is an enlarged cross-sectional view taken along line 11-11 of FIG. 10;

FIG. 12 is a front view of a gas fired oven wherein the various structural components are approximately drawn to scale but with thickness enlarged for clarity, with the door removed and showing a preferred form of steam generator and a preferred positioning of the heated air exhaust or discharge vents; and

FIG. 13 is a cross-sectional view taken along line 13-13 of FIG. 12.

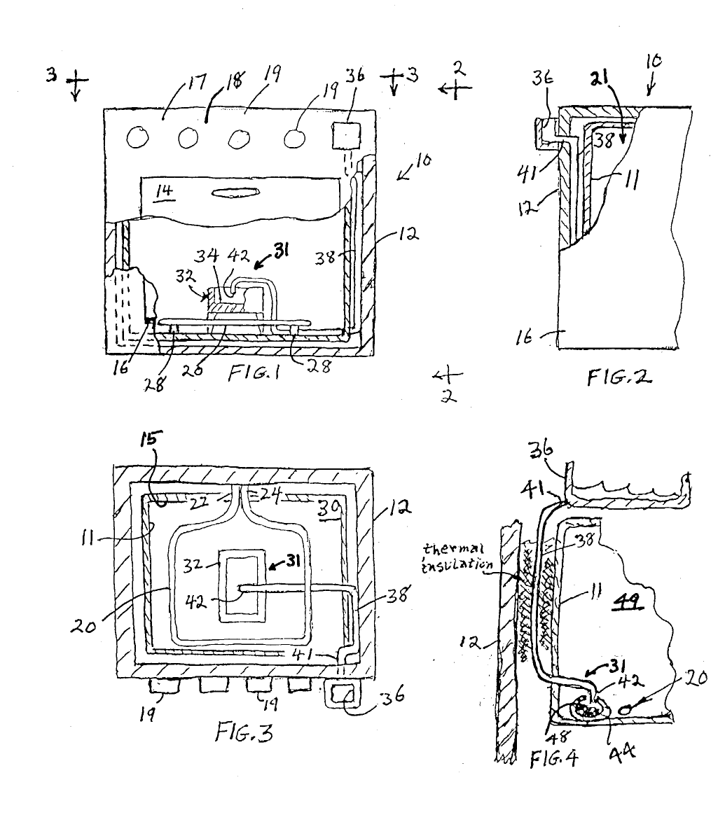

### DETAILED DESCRIPTION

Referring to the drawings, a typical home oven 10 is shown as having an oven cavity means 49 formed by wall 11 which is spaced from outer wall 12 of the oven cabinet generally designated 23 for heat insulation whereby wall 11 provides a lower high heat portion 13 and an upper cooler air portion 21 in the cavity means 49. Provided for the oven are the structures of an oven door 14 conventionally hinged at the lower portion 16 of wall 12, a control panel 17 with control knobs 19 at the upper portion 18 of wall 12, and a loop-like electrical heating element 20 having its power/ground electrical connection ends 22, 24 inserted thru the rear or back portion 15 of cavity wall 11. Foot members 28 keep the heating element elevated a short distance above the oven floor or baffle plate means 30. Cabinet 23 as shown in FIGS. 12 and 13 has a front portion 68, sides 69, back wall 71 and top 73.

The present steam generator generally designated 31, in one embodiment, comprises a stainless steel open top body 32 having a thick base or flash pan 34, i.e., about ½ in. thick which functions also as a heat sink. A useful set of dimensions for body 32 is about 3 in. outside height, about 8 in. long on the inside, and about 3 in. wide on the inside. These dimensions can vary depending how much water one wishes to flash into steam and how fast.

The water is poured as needed into a reservoir 36 of, e.g., about 4-8 oz. capacity, preferably mounted on the front of wall portion 18 and is conducted thru a small metal tube or line 38 such as a ⅛ in. I.D. copper or stainless steel tubing. This line is affixed to the inside of wall 12 and runs, as shown, into the open top of body 32 without contacting heating element 20. The inlet end 41 or outlet end 42 of line 38 can be pinched as desired to feed the water onto flash pan 34 at a desired rate.

Referring to FIGS. 4-7, a much preferred steam generating body 44 preferably of tubular stainless steel pipe of, e.g., 1½ in. I.D. and 9 in. length, capped at both ends is employed and is provided with holes 46, one of which connects with outlet end 42 of line 38 and the others allowing the escape of steam. A bed 48 of ⅛″ to ½″, preferably ¼″ diameter stainless steel balls is positioned in the tube to provide a mass to capture sufficient heat prior to introduction of water to flash the water from the tube when needed.

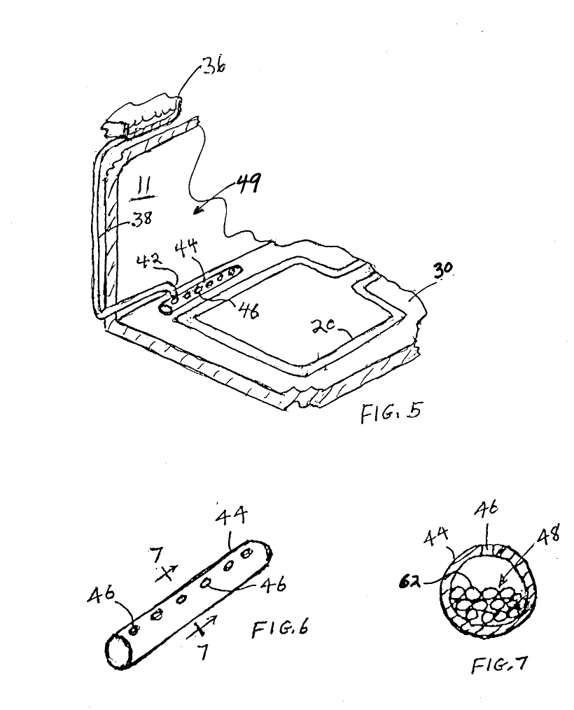

The position of the generator as shown in FIG. 5 within the oven cavity 49 is quite significant in that it is juxtaposed but not touching the heating element 20 so that the generator is maximally effective in absorbing radiant heat but doesn't block the heating element such as to cause a cold spot in the oven.

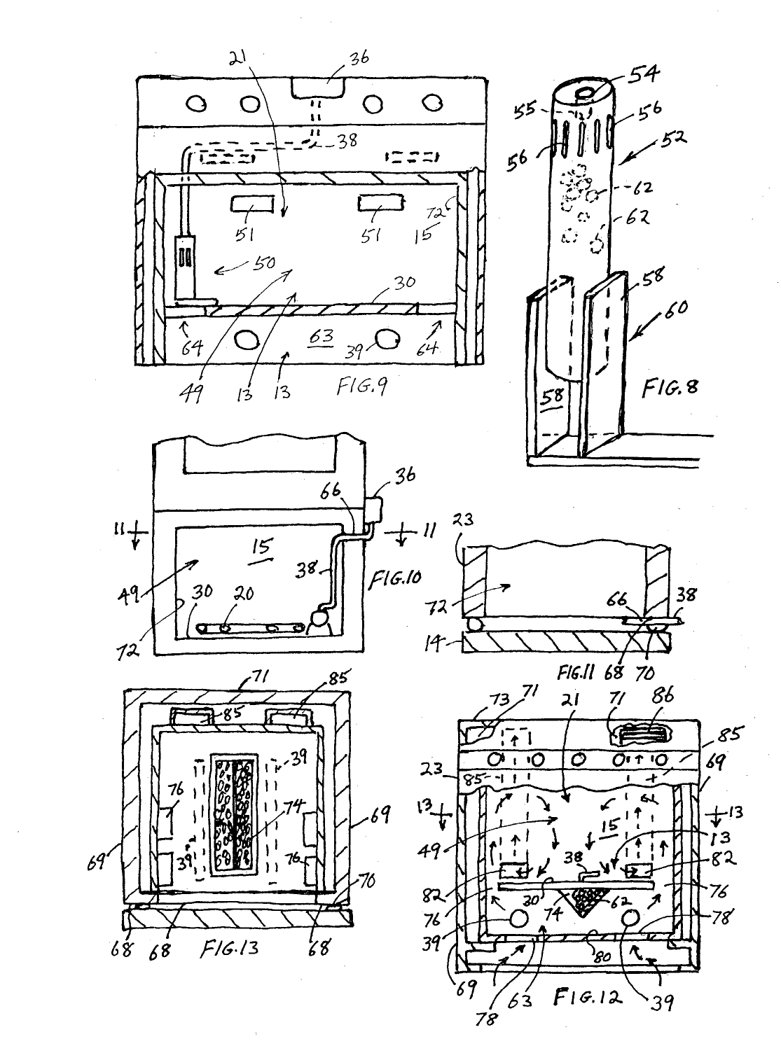

Referring to FIGS. 8 and 9 concerning a gas fired oven having gas burners 39, this particular embodiment 50 of the steam generator comprises a substantially vertically mounted tube 52 of about 12 in. in length, preferably stainless steel, schedule 40, having a top inlet pipe 54 connected to feed line 38 extending into tube 52 about, e.g., 1½ in., having a plurality of slots 56 of about, e.g., ¾ in. length and 3/16 in. width spaced, e.g., 30 degrees around the tube, and being welded to sides 58 of bracket 60.

The tube 52 is filled with, e.g., ¼ in, diameter stainless steel balls 62, preferably up to just below the inner end 55 of pipe 54. Bracket 60 is mounted, e.g., by welding to the oven base plate or floor 30 such that tube 52 is directly in the path of the HTA rising from burner chamber 63 thru inlet 64 into oven cavity 49. After circulation of the heated air in cavity 49 it is discharged to the atmosphere thru discharge vents such as 51 thru the back portion 84 of wall 11.

In FIGS. 10 and 11 the structure of the entry of water feed line 38 into oven cavity 49 is shown as simply interposing a generally laterally oriented section 66 of the line between a front portion 68 of the oven housing and a conventional compressible seal member 70 which is affixed to the oven door 14 so as to substantially heat and air seal the oven access opening generally designated 72 when the door is shut against the oven housing front. This seal 70 is sufficiently compressible to easily conform around line section 66 to maintain a good heat and air seal when the oven door is closed.

Referring to FIGS. 12 and 13, a very efficient gas fired oven construction is shown and comprises individually and/or in combination a unique heated air flow pattern and structure within the oven and a unique steam generator structure. The steam generator comprises a plate member which preferably is the oven floor 30 formed with a recess such as 74 which can be V shaped or concavely curved or the like and which can extend for any desired length along the floor, preferably laterally between the gas burners 39 located below the floor 30 in burner chamber 63. This recess should be dimensioned to hold a substantial quantity of steel balls or the like, preferably at least about two pounds for a typical home use oven.

The HTA from the burner chamber enters into the oven cavity 49 thru ports 76 in floor 30 of any selected size and number, and fresh air is fed into the burner chamber thru suitable vents such as 78 in the burner chamber floor 80. In this preferred construction, the heated air discharge vents 82 are provided thru the back portion 84 of wall 11, substantially adjacent the bottom thereof, e.g., starting 1-6 inches from floor 30, for venting to the atmosphere. Preferably, vent ducts such as 85 are provided to direct the exhaust air to a desirable vent location such as louvered openings 86 to the atmosphere. This location of the vents 82 ensures that the upward HTA flow and the downward cooler air flow will be forced into a generally circular flow pattern substantially as indicated by the flow arrows in FIG. 12.

This airflow pattern reduces the heat up time for achieving a baking temperature of, e.g., about 450° F. from about 43 minutes to about 19 minutes and markedly improves the evenness of temperature throughout the oven with or without the use of convection fans. Also, when a steam generator is employed with this unique air flow pattern, more steam is trapped within the oven cavity for a longer period of time which results in more efficient heating in the oven which greatly reduces the duration of the gas burn periods and the bum frequency, and course also reduces the cost of operating the oven.

This invention has been described in detail with particular reference to preferred embodiments thereof, but it will be understood that variations and modifications will be effected within the spirit and scope of the invention.

I claim:

1. Oven construction comprising first wall means forming a substantially closed oven cabinet, second wall means forming a substantially closed oven cavity means having an upper portion and a lower portion, HTA supply means mounted in said lower portion of said cavity means for generating a rising HTA flow within said cavity means, and air flow outlet means formed thru a lower section of said second wall means, whereby said HTA from said supply means will rise into said upper portion of said cavity means and then as it becomes cooler will gravitate downwardly into said lower portion of said cavity means and exit thru said outlet means, whereby said HTA will be forced to travel a longer residence path within said cavity means and release a larger amount of heat energy into said cavity means prior to discharge of said HTA therefrom.

2. The oven construction of claim 1 wherein a steam generator means is mounted in said cavity means and comprises water inlet means, heat sink means, steam outlet means, water reservoir means mounted on the exterior of said first wall means on an upper portion thereof, and water feed line means passing thru said first and second wall means and into said cavity means and having one end connected to said reservoir means and having its other end juxtaposed said inlet means, whereby a measured amount of water can be poured into said reservoir means and conducted thru said feed line means into said inlet means and into contact with said heat sink means to produce a desired amount of steam within said cavity means.

3. The oven construction of claim1 wherein said HTA supply means comprises a gas burner installation.

4. The oven construction of claim 3 wherein said outlet means are in air flow communication with air flow duct means which extend upwardly from said outlet means to adjacent the top portion of a back wall of said first wall means of said oven cabinet, and wherein vent openings are provided in said top portion and are in air flow communication with said duct means to vent gas combustion exhaust gases.

5. The oven construction of claim 4 wherein baffle plate means is mounted in said cavity means to substantially separate said gas burner installation from the remainder of said cavity means, wherein said heat sink means comprises a recess indention, in said baffle plate means, and wherein a plurality of metal pieces are contained in said indentation.

6. The oven construction of claim 5 wherein said metal pieces are stainless steel balls.

7. The oven construction of claim 1 wherein said HTA supply means comprises an electrical heating element.

8. Oven construction comprising first wall means forming a substantially closed oven cabinet, second wall means forming a substantially closed oven cavity means having an upper portion and a lower portion, HTA supply means mounted in said lower portion of said cavity means for generating a rising HTA flow within said cavity means steam generator means mounted in said cavity means and comprising water inlet means, heat sink means, steam outlet means, water reservoir means mounted on the exterior of said first wall means on an upper portion thereof, and water feed line means passing thru said first and second wall means and into said cavity means and having one end connected to said reservoir means and having its other end juxtaposed said inlet means, whereby a measured amount of water can be poured into said reservoir means and conducted thru said feed line means into said inlet means and into contact with said heat sink means to produce a desired amount of steam within said cavity means.

9. The oven construction of claim 8 wherein said HTA supply means is an electrical heating element.

10. The oven construction of claim 3 wherein said steam generator means is mounted in said cavity means directly within the upwardly directed HTA flow from the gas burner installation.
